(19) United States
(12) Patent Application Publication
(10) Pub. No.: US 2025/0367707 A1
(43) Pub. Date: Dec. 4, 2025

(54) PARCEL SEPARATION SYSTEMS AND METHODS

(71) Applicant: GENYE TECHNOLOGY COMPANY LIMITED, Guangzhou (CN)

(72) Inventors: Shengze CHEN, Guangzhou (CN); Zhenger LI, Guangzhou (CN)

(73) Assignee: GENYE TECHNOLOGY COMPANY LIMITED, Guangzhou (CN)

(21) Appl. No.: 19/227,431

(22) Filed: Jun. 3, 2025

(30) Foreign Application Priority Data
Jun. 3, 2024 (CN) 202410709934.6

(51) Int. Cl. B07C 3/18; B07C 3/08; B07C 3/14

(52) U.S. Cl. CPC B07C 3/18; B07C 3/08; B07C 3/14; B07C 2301/005

(57) ABSTRACT

The present disclosure relates to a parcel separation system and method. The parcel separation system includes a goods distribution zone connected to at least two automatic feeding lines. The goods distribution zone is configured to convey a plurality of parcels to the at least two automatic feeding lines. Each of the automatic feeding lines is sequentially provided with a stacked parcel separation zone, a parallel separation zone, a centering and double-removal zone, a wheel loading zone, an abnormal parcel assembly line, a goods import zone, a feeding platform loading zone, and a five-sided scanning and code-reading zone. The parcel separation method is performed by the parcel separation system.

### CROSS REFERENCE TO RELATED APPLICATIONS

This application claims priority to Chinese Patent Application No. 202410709934.6, filed on Jun. 3, 2024, the entire contents of which are incorporated herein by reference.

### TECHNICAL FIELD

The present disclosure relates to the field of automatic feeding technologies, and in particular, to parcel separation systems and methods.

### BACKGROUND

With rapid growth of logistics demand and continuous reinforcement of the logistics industry by the government, express logistics assembly lines will play an increasingly important role in the future. The operation of the express logistics assembly lines is generally divided into four stages: cargo sorting, cargo management, order processing, and delivery services.

However, during cargo sorting, classification and transfer of parcels are inevitably required. Conventional classification and transfer methods generally involve manually classifying parcels, followed by batch transfer of the classified parcels using equipment. Moreover, with the rapidly increasing volume of order sorting, manual classification and transfer are evidently inefficient and labor-intensive. Prolonged manual sorting operations tend to cause operator fatigue, resulting in reduced sorting efficiency and increased error rates. Manual sorting also presents various inconveniences during classified transportation and is prone to causing accumulation of parcels.

Under existing feeding methods, given the large volume of parcels, even after manual classification followed by transfer using equipment, a considerable number of parcels still remain to be processed, often resulting in parcel accumulation. In addition, continued manual sorting in subsequent stages tends to cause operator fatigue, reduced sorting efficiency, and increased likelihood of errors or omissions.

Therefore, there is a need to provide a parcel separation system and method configured to enable automatic conveying and classification of parcels.

### SUMMARY

One or more embodiments of the present disclosure provide a parcel separation system, comprising: a goods distribution zone connected to at least two automatic feeding lines, wherein the goods distribution zone is configured to convey a plurality of parcels to the at least two automatic feeding lines, and each of the automatic feeding lines sequentially includes: a stacked parcel separation zone configured to separate stacked parcels; a parallel separation zone configured to separate and space apart parcels which are parallel or side-by-side, wherein a separation interval between the parcels is adjustable; a centering and double-removal zone configured to photograph the parcels, analyze a single-parcel separation status of the parcels, and transfer a normal single parcel to a wheel loading zone based on the single-parcel separation status; the wheel loading zone, cooperating with the centering and double-removal zone, configured to receive parcel position information from the centering and double-removal zone and transfer separated parcels to a goods import zone based on the parcel position information; an abnormal parcel assembly line, cooperating with the wheel loading zone, configured to receive at least partially unseparated parcels and transfer the unseparated parcels back to the goods distribution zone; the goods import zone, configured to receive the separated parcels from the wheel loading zone; a feeding platform loading zone, cooperating with the goods import zone, configured to receive the separated parcels and read first barcode information; and a five-sided scanning and code-reading zone, configured to read second barcode information.

One or more embodiments of the present disclosure provide a parcel separation method, wherein the method is performed using a parcel separation system; and the parcel separation system includes: a goods distribution zone connected to at least two automatic feeding lines, wherein the goods distribution zone is configured to convey a plurality of parcels to the at least two automatic feeding lines, and each of the automatic feeding lines sequentially includes: a stacked parcel separation zone configured to separate stacked parcels; a parallel separation zone configured to separate and space apart parcels which are parallel or side-by-side, wherein a separation interval between the parcels is adjustable; a centering and double-removal zone configured to photograph the parcels, analyze a single-parcel separation status of the parcels, and transfer a normal single parcel to a wheel loading zone based on the single-parcel separation status; the wheel loading zone, cooperating with the centering and double-removal zone, configured to receive parcel position information from the centering and double-removal zone and transfer separated parcels to a goods import zone based on the parcel position information; an abnormal parcel assembly line, cooperating with the wheel loading zone, configured to receive at least partially unseparated parcels and transfer the unseparated parcels back to the goods distribution zone; the goods import zone, configured to receive the separated parcels from the wheel loading zone; a feeding platform loading zone, cooperating with the goods import zone, configured to receive the separated parcels and read first barcode information; and a five-sided scanning and code-reading zone, configured to read second barcode information.

### BRIEF DESCRIPTION OF THE DRAWINGS

The present disclosure will be further described by way of exemplary embodiments, which will be described in detail with reference to the accompanying drawings. These embodiments are not intended to be limiting. In the embodiments, identical reference numerals indicate identical structures, wherein:

FIG. 1 is a schematic diagram illustrating a top view of a parcel separation system according to some embodiments of the present disclosure;

FIG. 2 is a schematic diagram illustrating a top view of a stacked parcel separation zone, a parallel separation zone, and a centering and double-removal zone according to some embodiments of the present disclosure;

FIG. 3 is a schematic diagram illustrating a side view of a first stacked parcel separation assembly according to some embodiments of the present disclosure;

FIG. 4 is a schematic diagram illustrating a side view of a parallel separation zone according to some embodiments of the present disclosure;

FIG. 5 is a schematic diagram illustrating a side view of a centering and double-removal zone according to some embodiments of the present disclosure;

FIG. 6 is a schematic diagram illustrating a top view of a wheel loading zone, a goods import zone, and a feeding platform loading zone according to some embodiments of the present disclosure;

FIG. 7 is a schematic diagram illustrating a side view of a wheel loading zone according to some embodiments of the present disclosure;

FIG. 8 is a schematic diagram illustrating a top view of a goods import zone according to some embodiments of the present disclosure;

FIG. 9 is a schematic diagram illustrating a top view of a feeding platform loading zone according to some embodiments of the present disclosure; and

FIG. 10 is a schematic diagram illustrating a top view of a connection portion between a feeding platform loading zone and a five-sided scanning and code-reading zone according to some embodiments of the present disclosure.

### DETAILED DESCRIPTION

In order to more clearly illustrate the technical solutions of the embodiments of the present disclosure, a brief introduction to the drawings used in the following description of the embodiments is provided below. It is apparent from the context that the drawings described below are merely examples or embodiments of the present disclosure. A person skilled in the art may apply the present disclosure to other similar scenarios based on these drawings without creative efforts. Unless apparent from the context or otherwise specified, identical reference numerals in the drawings refer to identical structures or operations.

It should be understood that the terms “system,” “device,” “unit,” and/or “module” used herein are merely methods for distinguishing components, elements, parts, sections, or assemblies at different hierarchical levels. However, other expressions may be substituted for these terms if they serve the same purpose.

Hereinafter, the present disclosure is further described with reference to the drawings and specific embodiments. It should be noted that, unless there is a conflict, the embodiments or technical features described below may be combined arbitrarily to form additional embodiments.

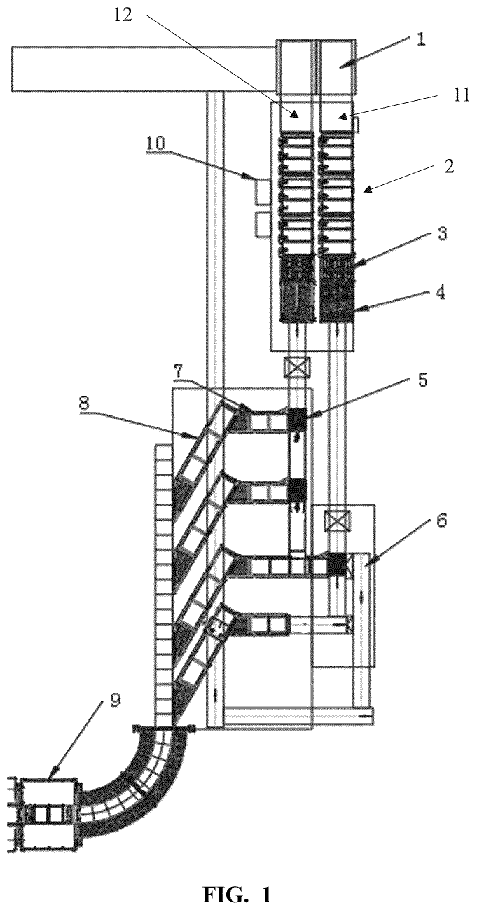

FIG. 1 is a schematic diagram illustrating a top view of a parcel separation system according to some embodiments of the present disclosure.

In some embodiments, as shown in FIG. 1, the parcel separation system includes a goods distribution zone 1, a stacked parcel separation zone 2, a parallel separation zone 3, a centering and double-removal zone 4, a wheel loading zone 5, an abnormal parcel assembly line 6, a goods import zone 7, a feeding platform loading zone 8, and a five-sided scanning and code-reading zone 9.

In some embodiments, the goods distribution zone 1 is connected to at least two automatic feeding lines (e.g., a first automatic feeding line 11 and a second automatic feeding line 12, as shown in FIG. 1). The goods distribution zone 1 is configured to simultaneously convey parcels to the at least two automatic feeding lines.

The automatic feeding line is configured to convey parcels. In some embodiments, each of the automatic feeding lines sequentially includes a stacked parcel separation zone 2, a parallel separation zone 3, a centering and double-removal zone 4, a wheel loading zone 5, an abnormal parcel assembly line 6, a goods import zone 7, a feeding platform loading zone 8, and a five-sided scanning and code-reading zone 9.

The stacked parcel separation zone 2 is configured to separate stacked parcels. That is, in the stacked parcel separation zone, a condition is handled in which at least a portion of a plurality of parcels (e.g., one parcel) is located above another portion of the plurality of parcels (e.g., another one parcel), so that the parcels are no longer stacked together, thereby achieving stack separation.

The parallel separation zone 3 is configured to separate and space apart parcels which are parallel and/or side-by-side, i.e., to separate parcels that are in side contact or nearly in side contact, and to increase a distance between the parcels, thereby achieving parallel parcel separation. The separation interval between the parcels (i.e., the distance between the parcels) is adjustable.

The centering and double-removal zone 4 is configured to photograph parcels, analyze a single-parcel separation status of the parcels, and transfer a normal single parcel to the wheel loading zone 5 based on the single-parcel separation status. The single-parcel separation status refers to a separation status of a single parcel from other parcels, and may include a stacked status of the single parcel and a parallel status of the single parcel. In some embodiments, the stacked status of the single parcel refers to a condition where no other parcel is located above the single parcel, and the parallel status of the single parcel refers to a condition where no other parcel is located beside the single parcel in a parallel and/or side-by-side manner. It is then determined that the single-parcel separation status meets a separation requirement. In some embodiments, a parcel having a single-parcel separation status that meets the separation requirement is regarded as a normal single parcel; and a parcel having a single-parcel separation status that does not meet the separation requirement is regarded as an abnormal parcel.

The wheel loading zone 5 may cooperate with the centering and double-removal zone 4 and is configured to receive parcel position information from the centering and double-removal zone, and transfer separated parcels to the goods import zone 7 based on the parcel position information.

The abnormal parcel assembly line 6 may cooperate with the wheel loading zone 5 and is configured to receive at least partially unseparated parcels, and transfer the unseparated parcels back to the goods distribution zone 1.

The goods import zone 7 is configured to receive the separated parcels from the wheel loading zone 5.

The feeding platform loading zone 8 may cooperate with the goods import zone 7 and is configured to receive the separated parcels and read first barcode information. In some embodiments, the first barcode information includes barcode information located on a bottom surface of a parcel. The barcode information refers to graphical identifiers expressing information, and may include various information such as an origin location, a source enterprise, a date, and an item category of the parcel.

The five-sided scanning and code-reading zone 9 is configured to read second barcode information. In some embodiments, the second barcode information includes barcode information located on a non-bottom surface of the parcel.

In some embodiments, the parcel separation system further includes a control box 10. The control box 10 may be in communication connection with the goods distribution zone 1, the stacked parcel separation zone 2, the parallel separation zone 3, the centering and double-removal zone 4, the wheel loading zone 5, the abnormal parcel assembly line 6, the goods import zone 7, the feeding platform loading zone 8, and the five-sided scanning and code-reading zone 9. The control box 10 is configured to process data/information related to functions of the goods distribution zone 1, the stacked parcel separation zone 2, the parallel separation zone 3, the centering and double-removal zone 4, the wheel loading zone 5, the abnormal parcel assembly line 6, the goods import zone 7, the feeding platform loading zone 8, and the five-sided scanning and code-reading zone 9, respectively, so as to control the parcel separation system to perform a parcel separation function. In some embodiments, the control box 10 may include at least one processing device (e.g., a single-core processing device or a multi-core processing device). Merely by way of example, the control box 10 may include an application-specific integrated circuit (ASIC), a programmable logic device (PLD), a controller, a microcontroller unit, a reduced instruction set computer (RISC), a microprocessor, or any combination thereof.

As an example, when the parcel separation system starts operating, a large number of unsorted parcels enter the automatic feeding lines from the goods distribution zone 1. The goods distribution zone 1 evenly conveys the parcels onto at least two automatic feeding lines. The parcels entering the automatic feeding lines first enter the stacked parcel separation zone 2, and stack separation is achieved in the stacked parcel separation zone 2, i.e., stacked parcels are separated into parcels normally placed flat on the automatic feeding lines. The parcels outputted from the stacked parcel separation zone 2 enter the parallel separation zone 3, and parallel separation is achieved in the parallel separation zone 3, i.e., parcels transported in parallel on the automatic feeding lines are separated into parcels transported independently and continuously. The parcels outputted from the parallel separation zone 3 enter the centering and double-removal zone 4, and discontinuous independent centering transport of the parcels is completed in the centering and double-removal zone 4. The parcels outputted from the centering and double-removal zone 4 enter the wheel loading zone 5. The wheel loading zone 5 cooperates with the centering and double-removal zone 4 to obtain parcel position information from the centering and double-removal zone 4, and identifies stacked parcels, parcels transported in parallel, and parcels transported independently and continuously based on the parcel position information. The above abnormal parcels (i.e., the stacked parcels and the parcels transported in parallel) are transferred to the abnormal parcel assembly line 6, while parcels transported independently and discontinuously are transferred to the goods import zone 7. The abnormal parcel assembly line 6 directly outputs the abnormal parcels to the goods distribution zone 1, whereas normal parcels outputted to the goods import zone 7 enter the feeding platform loading zone 8. The feeding platform loading zone 8 reads barcode information located on the bottom surface of the parcels and outputs the parcels to the five-sided scanning and code-reading zone 9. The five-sided scanning and code-reading zone 9 reads barcode information located on the other five surfaces of the parcels except the bottom surface. Finally, the parcels are discharged from the automatic feeding lines, achieving classified parcel transportation.

By sequentially arranging a stacked parcel separation zone, a parallel separation zone, a centering and double-removal zone, a wheel loading zone, an abnormal parcel assembly line, a goods import zone, a feeding platform loading zone, and a five-sided scanning and code-reading zone on each of at least two automatic feeding lines, automatic transportation of all parcels on the automatic feeding lines is achieved. The barcode information on surfaces of parcels is read by the five-sided scanning and code-reading zone, thereby achieving classified transportation of parcels, avoiding errors caused by manual fatigue, and reducing accumulation of parcels.

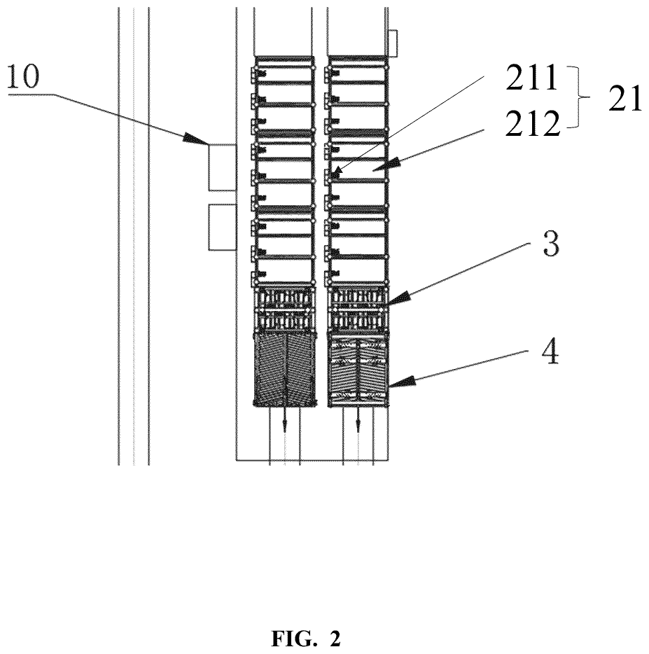

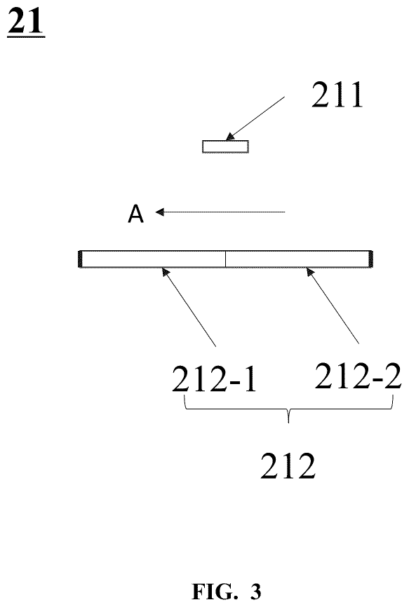

FIG. 2 is a schematic diagram illustrating a top view of a stacked parcel separation zone, a parallel separation zone, and a centering and double-removal zone according to some embodiments of the present disclosure. FIG. 3 is a schematic diagram illustrating a side view of a first stacked parcel separation assembly according to some embodiments of the present disclosure. The side view in FIG. 3 corresponds to the direction from the right side to the left side in FIG. 2.

In some embodiments, as shown in FIG. 2, the stacked parcel separation zone 2 includes a plurality of stacked parcel separation assemblies (e.g., a first stacked parcel separation assembly 21 shown in FIG. 2). As shown in FIGS. 2 and 3, each stacked parcel separation assembly (e.g., the first stacked parcel separation assembly 21) includes a stacking zone camera 211 and a separation zone conveyor belt 212. The stacking zone camera 211 is disposed above the separation zone conveyor belt 212. The count of the stacking zone cameras 211 above the separation zone conveyor belt 212 may be one or more. In some embodiments, the separation zone conveyor belt 212 includes a front segment conveyor belt 212-1 and a rear segment conveyor belt 212-2. The front segment conveyor belt 212-1 and the rear segment conveyor belt 212-2 may be sequentially arranged along the parcel advancing direction A. In some embodiments, one stacking zone camera 211 may be respectively disposed above the front segment conveyor belt 212-1 and the rear segment conveyor belt 212-2.

In some embodiments, a conveying speed of the front segment conveyor belt 212-1 and a conveying speed of the rear segment conveyor belt 212-2 may be set respectively, and may be the same or different. In some embodiments, the parcel separation system may obtain a parcel stacking status on the separation zone conveyor belt 212 via the stacking zone camera 211, for example, by capturing images through the stacking zone camera 211 and acquiring the parcel stacking status through image recognition. In some embodiments, the parcel separation system may control the conveying speeds of the front segment conveyor belt 212-1 and the rear segment conveyor belt 212-2, respectively, based on the parcel stacking status.

In some embodiments, the conveying speed of the front segment conveyor belt 212-1 may be greater than the conveying speed of the rear segment conveyor belt 212-2.

By making the conveying speed of the front segment conveyor belt greater than the conveying speed of the rear segment conveyor belt, a conveying speed difference formed between the front and rear segments of the separation zone can be utilized to implement stack separation of stacked parcels in the stacked parcel separation assembly.

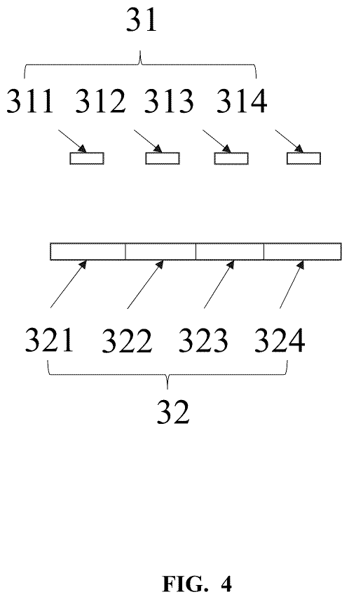

FIG. 4 is a schematic diagram illustrating a side view of a parallel separation zone according to some embodiments of the present disclosure. The side view shown in FIG. 4 corresponds to a direction from the lower side to the upper side in FIG. 2.

In some embodiments, as shown in FIGS. 2-4, the parallel separation zone 3 includes a plurality of parallel zone cameras 31 and a plurality of conveyor belts 32. Each of the parallel zone cameras 31 is correspondingly disposed above one of the conveyor belts 32. For example, a first parallel zone camera 311 is disposed above a first conveyor belt 321, a second parallel zone camera 312 is disposed above a second conveyor belt 322, a third parallel zone camera 313 is disposed above a third conveyor belt 323, and a fourth parallel zone camera 314 is disposed above a fourth conveyor belt 324.

In some embodiments, the parcel separation system may obtain belt positions occupied by all parcels in the parallel separation zone via the parallel zone cameras, sort the parcels based on the belt positions, and update a moving speed of a parcel closest to an exit of the parallel separation zone, so as to gradually increase a distance between the parcel and other parcels ranked behind, such that the parcel can be extracted and conveyed to the centering and double-removal zone 4. In some embodiments, a conveyor belt occupied by a parcel to be separated and conveyor belts to be passed by the parcel to be separated are accelerated in advance, while movement speeds of conveyor belts occupied by remaining parcels are reduced or stopped, so as to increase a spacing between the parcel to be separated and the remaining parcels and achieve separation.

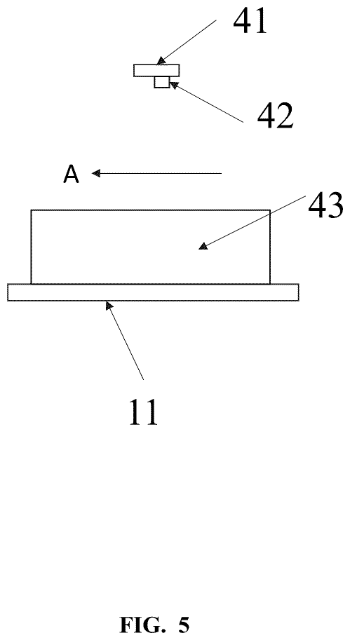

FIG. 5 is a schematic diagram illustrating a side view of a centering and double-removal zone according to some embodiments of the present disclosure. The side view in FIG. 5 corresponds to a direction from the right side to the left side as shown in FIG. 2.

In some embodiments, as shown in FIG. 5, the centering and double-removal zone 4 includes a double-removal zone camera 41, a double-removal zone sensor 42, and a centering mechanism 43. The double-removal zone camera 41 is located above the automatic feeding line 11, the double-removal zone sensor 42 is located at a bottom of the double-removal zone camera 41, and the centering mechanism 43 is located on the automatic feeding line 11.

In some embodiments, the parcel separation system may photograph the parcels via the double-removal zone camera 41, analyze the single-parcel separation status (e.g., obtain the single-parcel separation status through image recognition), and transfer the normal single parcel to the wheel loading zone 5 based on the single-parcel separation status.

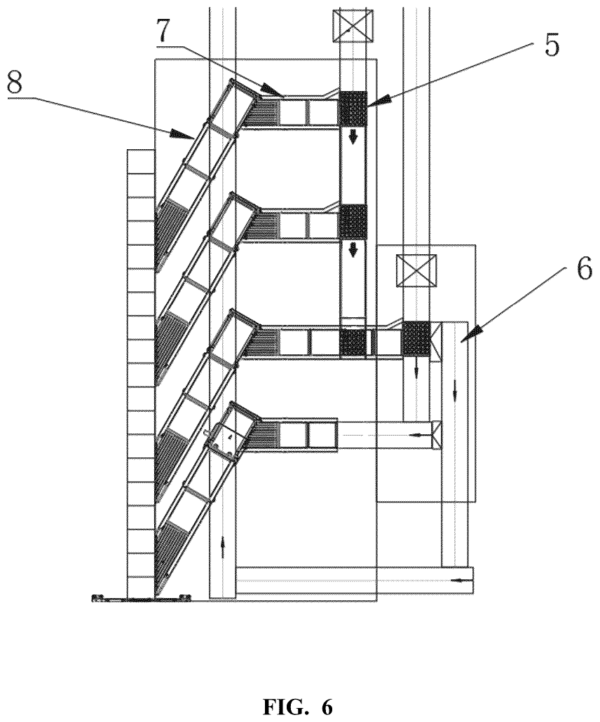

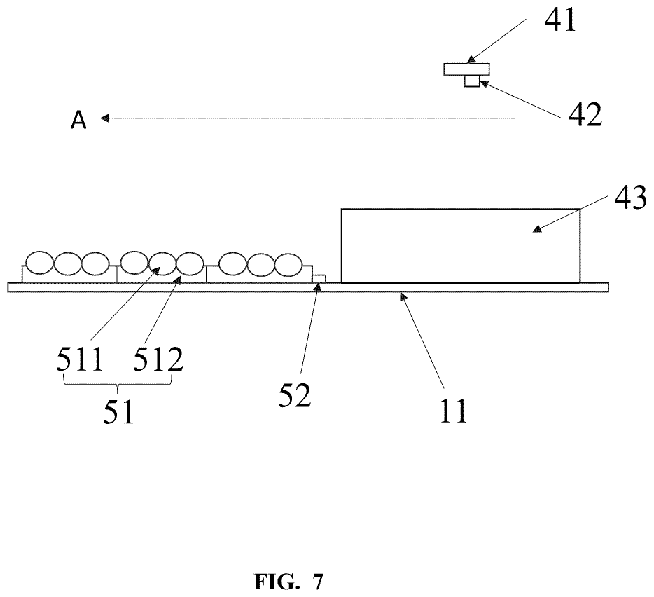

FIG. 6 is a schematic diagram illustrating a top view of a wheel loading zone, a goods import zone, and a feeding platform loading zone according to some embodiments of the present disclosure. FIG. 7 is a schematic diagram illustrating a side view of a wheel loading zone according to some embodiments of the present disclosure. The side view of FIG. 7 corresponds to a direction from the right side to the left side in FIG. 6.

In some embodiments, as shown in FIGS. 6 and 7, the wheel loading zone 5 includes a plurality of wheel assemblies 51 and a plurality of wheel sensors 52. Each of the wheel assemblies 51 includes a plurality of rotating wheels 511 and a wheel base 512. The plurality of rotating wheels 511 are rotatably mounted on the wheel base 512. In some embodiments, the wheel bases of the plurality of wheel assemblies 51 are located on the automatic feeding line 11, the plurality of wheel sensors 52 are located between the centering and double-removal zone 4 and the wheel assemblies 51 along an inner edge of the automatic feeding line 11, and cooperate with the plurality of wheel assemblies 51.

In some embodiments, the centering mechanism 43 is provided with a plurality of rotating rollers which are arranged obliquely and whose rotating direction is the center of the automatic feeding line 11, and vertical heights of the rotating rollers decrease sequentially. When a parcel enters the centering and double-removal zone 4, the double-removal zone sensor 42 detects the parcel and triggers the double-removal zone camera 41 to capture an image. The double-removal zone camera 41 captures the image and identifies stacked parcels that have not been separated, parcels transported in parallel, and parcels transported independently and continuously. The wheel loading zone 5 detect the parcels using the wheel sensors 52 based on data from the double-removal zone camera 41, outputs abnormal parcels to the abnormal parcel assembly line 6, and simultaneously outputs normal parcels to the goods import zone 7.

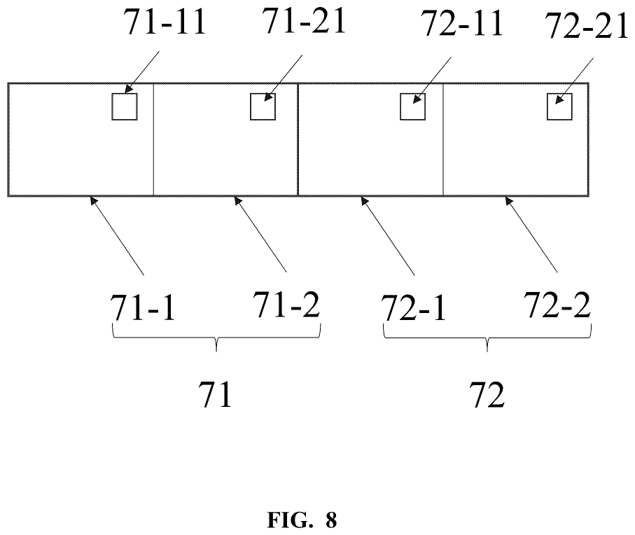

FIG. 8 is a schematic diagram illustrating a top view of a goods import zone according to some embodiments of the present disclosure.

In some embodiments, as shown in FIGS. 6 and 8, the goods import zone 7 includes a plurality of import assemblies (such as a first import assembly 71 and a second import assembly 72 as shown in FIG. 7) that are interconnected, and each of the import assemblies includes a plurality of servo carts equipped with sensors. For example, as shown in FIG. 8, the first import assembly 71 includes a first servo cart 71-1 and a second servo cart 71-2. A first sensor 71-11 is disposed on the first servo cart 71-1, and a second sensor 71-21 is disposed on the second servo cart 71-2. The second import assembly 72 includes a third servo cart 72-1 and a fourth servo cart 72-2. A third sensor 72-11 is disposed on the third servo cart 72-1, and a fourth sensor 72-21 is disposed on the fourth servo cart 72-2. In some embodiments, a sensor is configured to sense a parcel transported to a position above a servo cart, such that the servo cart transports the parcel to a rotating roller of a tail-end servo cart. The rotating roller transports the parcel to the feeding platform loading zone 8. The principle of the rotating roller is the same as that of the centering rotating roller and will not be described in detail herein.

In some embodiments, the abnormal parcel assembly line 6 is configured to transfer the at least partially unseparated parcels from the wheel loading zone 5 to the goods distribution zone 1 via at least one of the import assemblies.

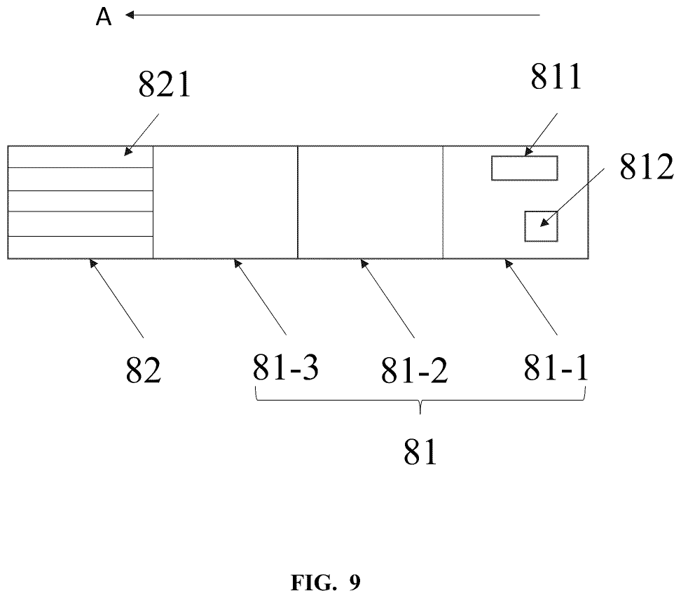

FIG. 9 is a schematic diagram illustrating a top view of a feeding platform loading zone according to some embodiments of the present disclosure.

In some embodiments, as shown in FIG. 9, the feeding platform loading zone 8 includes a plurality of feeding platform carts 81 (e.g., a first feeding platform cart 81-1, a second feeding platform cart 81-2, and a third feeding platform cart 81-3 shown in FIG. 9) and a device loop cart 82 that are sequentially connected. The device loop cart 82 is rotatably mounted with a plurality of rotating rollers 821, and each of the plurality of feeding platform carts 81 is equipped with a light curtain 811 and a bottom-scanning camera 812. The light curtain 811 may cooperate with the bottom-scanning camera 812 to read first barcode information, i.e., barcode information located at a bottom surface of the parcel. If there is no barcode information at the bottom surface of the parcel, the reading result is empty.

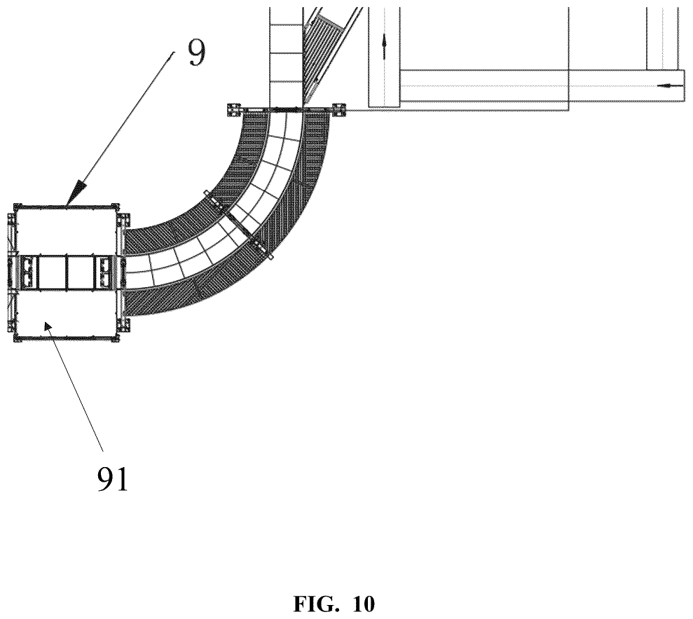

FIG. 10 is a schematic diagram illustrating a top view of a connection portion between a feeding platform loading zone and a five-sided scanning and code-reading zone according to some embodiments of the present disclosure.

In some embodiments, as shown in FIG. 10, the five-sided scanning and code-reading zone 9 is equipped with a five-sided scanning device 91. The five-sided scanning device 91 is configured to scan five surfaces of a parcel other than a bottom surface, so as to ensure that barcode information located on the surfaces of the parcel is read, i.e., to read second barcode information.

In some embodiments of the present disclosure, by providing the stacked parcel separation zone, the parallel separation zone, the centering and double-removal zone, the wheel loading zone, the abnormal parcel assembly line, the goods import zone, and the feeding platform loading zone, a complete parcel separation and transportation assembly line is formed. All parcels entering the parcel separation system are separated into individual parcels, and parcels that are not completely separated are transported back to the goods distribution zone for re-separation, which facilitates subsequent processing of the parcels and improves sorting efficiency.

In some embodiments of the present disclosure, a parcel separation method is further provided, the method being performed using the parcel separation system according to any of the foregoing embodiments.

In some embodiments, the parcel separation method may include conveying the plurality of parcels to the at least two automatic feeding lines via the goods distribution zone. It is understood that each automatic feeding line performs the same operations. By providing a plurality of automatic feeding lines, the efficiency of parcel separation can be improved.

In some embodiments, the parcel separating method further includes: for parcels conveyed to each of the at least two automatic feeding lines, performing stack separation on the parcels in the stacked parcel separation zone 2 and performing parallel separation on the parcels in the parallel separation zone 3; conveying the parcels to the centering and double-removal zone 4, performing discontinuous independent centering transport in the centering and double-removal zone 4, and then conveying the parcels to the wheel loading zone 5; and obtaining the parcel position information from the centering and double-removal zone 4 by the wheel loading zone 5, determining whether the parcels are abnormal based on the parcel position information, and transferring the parcels based on a determination result. The parcel position information is used to indicate a position of the parcel. In some embodiments, stacked parcels, parcels transported in parallel, and parcels transported continuously and independently among a plurality of parcels can be identified based on the parcel position. For example, the double-removal zone camera 41 in the centering and double-removal zone 4 may photograph the parcels and obtain the parcel position information via image recognition; the wheel loading zone 5 may acquire the parcel position information from the centering and double-removal zone 4 and determine whether the parcel is an abnormal parcel or a normal parcel based on the parcel position information. In some embodiments, when a distance between a parcel and other parcels is less than or equal to a preset distance threshold, the parcel is considered as an abnormal parcel; and when the distance between the parcel and other parcels is greater than the preset distance threshold, the parcel is considered as a normal parcel. The normal parcel may be a parcel that has been completely separated, and the abnormal parcel may be a parcel that has not been completely separated.

In some embodiments, when the parcel is determined as the abnormal parcel, the abnormal parcel is transferred to the abnormal parcel assembly line 6, which conveys the abnormal parcel back to the goods distribution zone 1 for parcel separation again.

In some embodiments, when the parcel is determined as the normal parcel, the normal parcel is transferred to the goods import zone 7, then to the feeding platform loading zone 8. The feeding platform loading zone 8 reads first barcode information of the normal parcel, the normal parcel is then conveyed to the five-sided scanning and code-reading zone 9, and after reading second barcode information of the normal parcel, the five-sided scanning and code-reading zone 9 discharges the normal parcel from the automatic feeding line.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. Furthermore, the particular features, structures, or characteristics may be combined as suitable in one or more embodiments of the present disclosure.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

Finally, it should be understood that the embodiments described in the present disclosure are only used to illustrate the principles of the embodiments of the present disclosure. In closing, it is to be understood that the embodiments of the application disclosed herein are illustrative of the principles of the embodiments of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A parcel separation system, comprising:
a goods distribution zone connected to at least two automatic feeding lines, wherein the goods distribution zone is configured to convey a plurality of parcels to the at least two automatic feeding lines, and each of the automatic feeding lines sequentially includes:
a stacked parcel separation zone configured to separate stacked parcels;
a parallel separation zone configured to separate and space apart parcels which are parallel or side-by-side, wherein a separation interval between the parcels is adjustable;
a centering and double-removal zone configured to photograph the parcels, analyze a single-parcel separation status of the parcels, and transfer a normal single parcel to a wheel loading zone based on the single-parcel separation status;
the wheel loading zone, cooperating with the centering and double-removal zone, configured to receive parcel position information from the centering and double-removal zone and transfer separated parcels to a goods import zone based on the parcel position information;
an abnormal parcel assembly line, cooperating with the wheel loading zone, configured to receive at least partially unseparated parcels and transfer the unseparated parcels back to the goods distribution zone;
the goods import zone, configured to receive the separated parcels from the wheel loading zone;
a feeding platform loading zone, cooperating with the goods import zone, configured to receive the separated parcels and read first barcode information; and
a five-sided scanning and code-reading zone, configured to read second barcode information.

2. The parcel separation system of claim 1, wherein the stacked parcel separation zone includes a plurality of stacked parcel separation assemblies, and each of the plurality of stacked parcel separation assemblies includes a stacking zone camera and a separation zone conveyor belt, wherein the stacking zone camera is located above the separation zone conveyor belt, and the separation zone conveyor belt includes a front segment conveyor belt and a rear segment conveyor belt.

3. The parcel separation system of claim 2, wherein the parcel separation system is configured to:
obtain a parcel stacking status on the separation zone conveyor belt via the stacking zone camera, and control conveying speeds of the front segment conveyor belt and the rear segment conveyor belt, respectively, based on the parcel stacking status.

4. The parcel separation system of claim 3, wherein the conveying speed of the front segment conveyor belt is greater than the conveying speed of the rear segment conveyor belt.

5. The parcel separation system of claim 1, wherein the parallel separation zone includes a plurality of parallel zone cameras and a plurality of conveyor belts, each of the plurality of parallel zone cameras being correspondingly located above one of the conveyor belts.

6. The parcel separation system of claim 5, wherein the parcel separation system is configured to:
obtain belt positions occupied by all parcels in the parallel separation zone via the parallel zone cameras, sort the parcels based on the belt positions, and update a moving speed of a parcel closest to an exit of the parallel separation zone.

7. The parcel separation system of claim 1, wherein the centering and double-removal zone includes a double-removal zone camera, a double-removal zone sensor, and a centering mechanism, wherein:
the double-removal zone camera is located above the automatic feeding line, the double-removal zone sensor is located at a bottom of the double-removal zone camera, and the centering mechanism is located on the automatic feeding line.

8. The parcel separation system of claim 7, wherein the parcel separation system is configured to:
photograph the parcels via the double-removal zone camera, analyze the single-parcel separation status, and transfer the normal single parcel to the wheel loading zone based on the single-parcel separation status.

9. The parcel separation system of claim 1, wherein the wheel loading zone includes a plurality of wheel assemblies and a plurality of wheel sensors, each of the plurality of wheel assemblies includes a plurality of rotating wheels and a wheel base, wherein:
the plurality of rotating wheels are rotatably mounted on the wheel base, wheel bases of the plurality of wheel assemblies are located on the automatic feeding line, and the plurality of wheel sensors are located between the centering and double-removal zone and the plurality of wheel assemblies along an inner edge of the automatic feeding line, and cooperate with the plurality of wheel assemblies.

10. The parcel separation system of claim 1, wherein the goods import zone includes a plurality of import assemblies that are interconnected, and each of the plurality of import assemblies includes a plurality of servo carts equipped with sensors.

11. The parcel separation system of claim 10, wherein the abnormal parcel assembly line is configured to transfer the at least partially unseparated parcels from the wheel loading zone back to the goods distribution zone via at least one of the import assemblies.

12. The parcel separation system of claim 1, wherein the feeding platform loading zone includes a plurality of feeding platform carts and a device loop cart that are sequentially connected, wherein:
the device loop cart is rotatably mounted with a plurality of rotating rollers, and each of the plurality of feeding platform carts is equipped with a light curtain and a bottom-scanning camera.

13. The parcel separation system of claim 1, wherein the five-sided scanning and code-reading zone is equipped with a five-sided scanning device.

14. The parcel separation system of claim 1, wherein:
the first barcode information includes barcode information located on a bottom surface of a parcel, and
the second barcode information includes barcode information located on a non-bottom surface of the parcel.

15. A parcel separation method, wherein the method is performed using the parcel separation system; and
the parcel separation system includes: a goods distribution zone connected to at least two automatic feeding lines, wherein the goods distribution zone is configured to convey a plurality of parcels to the at least two automatic feeding lines, and each of the automatic feeding lines sequentially includes:
a stacked parcel separation zone configured to separate stacked parcels;
a parallel separation zone configured to separate and space apart parcels which are parallel or side-by-side, wherein a separation interval between the parcels is adjustable;
a centering and double-removal zone configured to photograph the parcels, analyze a single-parcel separation status of the parcels, and transfer a normal single parcel to a wheel loading zone based on the single-parcel separation status;
the wheel loading zone, cooperating with the centering and double-removal zone, configured to receive parcel position information from the centering and double-removal zone and transfer separated parcels to a goods import zone based on the parcel position information;
an abnormal parcel assembly line, cooperating with the wheel loading zone, configured to receive at least partially unseparated parcels and transfer the unseparated parcels back to the goods distribution zone;
the goods import zone, configured to receive the separated parcels from the wheel loading zone;
a feeding platform loading zone, cooperating with the goods import zone, configured to receive the separated parcels and read first barcode information; and
a five-sided scanning and code-reading zone, configured to read second barcode information.

16. The parcel separation method of claim 15, comprising:
conveying the plurality of parcels to the at least two automatic feeding lines via the goods distribution zone.

17. The parcel separation method of claim 16, further comprising:
for parcels conveyed to each of the at least two automatic feeding lines,
performing stack separation on the parcels in the stacked parcel separation zone and performing parallel separation on the parcels in the parallel separation zone;
conveying the parcels to the centering and double-removal zone, performing discontinuous independent centering transport in the centering and double-removal zone, and then conveying the parcels to the wheel loading zone; and
obtaining the parcel position information from the centering and double-removal zone by the wheel loading zone, determining whether the parcels are abnormal based on the parcel position information, and transferring the parcels based on a determination result.

18. The parcel separation method of claim 17, further comprising:
when a parcel is determined as an abnormal parcel, transferring the abnormal parcel to the abnormal parcel assembly line, which conveys the abnormal parcel back to the goods distribution zone; and
when a parcel is determined as a normal parcel, transferring the normal parcel to the goods import zone, then to the feeding platform loading zone, wherein:
after the feeding platform loading zone reads first barcode information of the normal parcel, the normal parcel is then conveyed to the five-sided scanning and code-reading zone, and after reading second barcode information of the normal parcel, the five-sided scanning and code-reading zone discharges the normal parcel from the automatic feeding line.
